(19) United States
(12) Patent Application Publication
(10) Pub. No.: US 2009/0172171 A1
(43) Pub. Date: Jul. 2, 2009

(54) METHOD AND AN APPARATUS FOR DISGUISING DIGITAL CONTENT

(76) Inventor: Shai AMIR, Kadima (IL)

Correspondence Address: MARTIN D. MOYNIHAN d/b/a PRTSI, INC., P.O. BOX 16446, ARLINGTON, VA, 22215, US

(21) Appl. No.: 12/265,832

(22) Filed: Nov. 6, 2008

Related U.S. Application Data
(60) Provisional application No. 61/006,219, filed on Dec. 31, 2007.

(51) Int. Cl. G06F 15/16; G06F 15/18

(52) U.S. Cl. 709/227; 706/8; 709/245

(57) ABSTRACT

A method for establishing a disguised communication session between communicating user terminals. The method comprises at a first communicating user terminal, providing data for a communication session with a second communicating user terminal, distributing the data among a plurality of proxy network nodes, and using the plurality of proxy network nodes for forwarding a plurality of flows to the second communicating user terminal, each the flow comprising a portion of the data. The distributing and forwarding is performed so as to disguise at least one characteristic of the communication session from at least one inspection entity probing the plurality of flows.

### RELATED APPLICATION

This application claims the benefit of U.S. Provisional Patent Application No. 61/006,219, filed on Dec. 31, 2007, the contents of which are incorporated herein by reference.

### FIELD AND BACKGROUND OF THE INVENTION

The present invention, in some embodiments thereof, relates to a method and is an apparatus for disguising a communication session and, more particularly, but not exclusively, to a method and an apparatus for disguising data of a communication session that is inspected by an inspection entity.

Network managing enterprises, such as cellular network providers and/or internet service providers (ISPs), monitor data flows as a matter of common practice. Simple network availability issues, quality of service (QoS), service level agreements (SLA), data transfer policy enforcement, network growth/deployment, and variety of security threats are all critical areas that require their attention. A network managing enterprise usually integrates an inspection entity such as a content inspection entity (CIE), which may be referred to as a content inspection director (CID), to deal with theses issues.

Usually, an inspection entity, such as a CIE, that monitor a certain network or a segment of a network, which may be referred to as a controlled network, is located to observe all the communication traffic between network nodes of the controlled network and network nodes of other networks. Because of cost, deployment complexity, and management overhead, inspection entities are usually placed in central locations in the network. An inspection entity is used for enforcing the data transfer policy of the managing entity of the network. For example, an inspection entity may be used for determining which applications may use the network resources and to what extent.

An inspection entity usually implements a packet firewall that intercepts packets transferred via a group of inspected channels, and verifies each packet against a set of firewall rules to accept, reject, and optionally log the packet. In addition to packet filtering, network administrators sometimes use packet filters to enforce traffic management policies. Such policies are useful, inter alia, in limiting or controlling offensive behavior.

Under a typical advanced firewall implementation, filtering is performed to based on applicable access control list (ACL) rules, such as 2500 Cisco ACL rules, which are designed to allow or reject specific activities or hosts. Cisco ACLs are usually divided into types such as standard internet protocol (IP) rules, extended IP rules, internet-work packet exchange (IPX) rules, Appletalk™ rules, and the like. In this instance, a highest-priority rule is usually identified based on the packet header information. For example, the rule may be identified based on a 5-tuple input corresponding to values for the source and destination addresses, source and destination ports, and protocol using well-known classification algorithms. Under some implementations, dedicated components or separate computers are employed for performing these filtering operations. In addition, other filtering applications may probe the traffic characteristics of the packet flows. These operations, known as behavioral inspection, involve inspecting the packet payload for predefined patterns and talking actions based on the presence or absence of these patterns.

Inspection entities, which are designated for enforcing data transfer policy, known as traffic management devices, and perform behavioral inspection, are known. Examples for such traffic management devices are NetEnforcer™ of Allot™, PacketShaper™ of Packeteer™, and VPN-1 or Firewall-1 of Checkpoint™.

### SUMMARY OF THE INVENTION

According to an aspect of some embodiments of the present invention there is provided a method for establishing a disguised communication session between communicating user terminals. The method comprises at a first communicating user terminal, providing data for a communication session with a second communicating user terminal, distributing the data among a plurality of proxy network nodes, and using the plurality of proxy network nodes for forwarding a plurality of flows to the second communicating user terminal, each the flow comprising a portion of the data. The distributing and forwarding is performed to disguise at least one characteristic of the communication session from at least one inspection entity probing the plurality of flows.

Optionally, the at least one characteristic is a behavioral pattern.

Optionally, the disguising prevents from the at least one inspection entity from receiving the data in a single flow.

Optionally, the plurality of proxy network nodes comprises at least one proxy user terminal.

Optionally, the plurality of proxy network nodes are configured for forwarding the plurality of flows in parallel.

Optionally, the data comprises a plurality of packets each has at least one routing tag, the distributing comprising changing the at least one routing tag.

More optionally, the at least one routing tag is a 5-tuple information.

Optionally, the communication session comprises a member of the group consisting of: a voice over internet protocol (VoIP) session, video conferencing session, online game session, and a file sharing session.

Optionally, each the proxy network node receives the portion via an intranetwork connection, the intranetwork connection not being monitored by the at least one inspection entity.

More optionally, the intranetwork connection is a peer-to-peer connection.

Optionally, the proxy network node is configured for forwarding a respective the flow via an additional proxy network node connected to the second communicating user terminal.

More optionally, the additional proxy network node is connected in a peer-to-peer connection to the second communicating user terminal.

Optionally, the method further comprises padding each the flow with dummy data before the forwarding.

Optionally, the communication session is a bidirectional session, the disguising comprising disguising the flow as a flow of a unidirectional communication session.

Optionally, each the flow is shorter than a flow of a non peer-to-peer (P2P) data traffic.

Optionally, the using comprises routing the flows to be probed by a plurality of inspection entities.

Optionally, the disguising is performed to increase the anonymously of the first communicating user terminal.

According to an aspect of some embodiments of the present invention there is provided a method for classifying a disgusted communication session. The method comprises managing a list comprising plurality of suspected user terminal addresses, reviewing a plurality of eavesdropped flows to select a group of eavesdropped flows each being related to one of the plurality of suspected user terminal addresses, aggregating the group of flows to induce an eavesdropped behavioral pattern, reviewing a plurality behavioral pattern each of a known communication session to select a match with the eavesdropped behavioral pattern, and classifying the group of flows according to the match.

Optionally, each the eavesdropped flow comprises at least one of the plurality of suspected user terminal addresses as a destination address or as a source address.

According to an aspect of some embodiments of the present invention there is provided a method for concealing the address of communicating user terminals. The method comprises at a first communicating user terminal having a first address, providing data for a communication session with a second communicating user terminal having a second address, distributing the data among a plurality of proxy network nodes, and using the plurality of proxy network nodes for forwarding a plurality of flows to the second communicating user terminal, each the flow comprising a portion of the data. The distributing and forwarding is performed to conceal the first and second addresses from at least one entity eavesdropping the plurality of flows.

According to an aspect of some embodiments of the present invention there is provided an apparatus for establishing a communication session with a communicating user terminal. The apparatus comprises a communicating module configured for establishing a plurality of connections with a plurality of proxy network nodes, and a session module configured for distributing data of the communication session via the plurality of connections, thereby using the plurality of proxy network nodes for disguising the communication session as a plurality of flows forwarded to the communicating user terminal, each the flow comprising a portion of the data. The at least one characteristic of the communication session is concealed from at least one inspection entity probing at least one of the plurality of flows.

Optionally, the apparatus is a member of the group consisting of: a mobile phone, a personal digital assistant (PDA), a laptop, and a personal computer.

Optionally, the communicating module is configured for establishing a plurality of peer-to-peer connections with the plurality of proxy network nodes.

Optionally, the session module is configured for padding the data with dummy data before the distributing.

Optionally, the communication session is a bidirectional session, further comprising a receiving module for receiving data flows from the communicating user terminal.

Optionally, the data flows are received via the plurality of connections.

Optionally, the communication session is configured for distributing the data to be routed via a plurality of different inspection entities.

According to an aspect of some embodiments of the present invention there is provided a system for allowing at least two user terminals to establish a disguised communication session. The system comprises at least one inspection entity configured for performing an inspection to at least one channel between a plurality of network node and a first and a second user terminal configured for establishing a communication session via the channels. The first user terminal is configured for distributing data of the communication session via the channels in at least two flows to disguise at least one characteristic of the communication session from an inspection entity probing the plurality of flows.

Optionally, the system further comprises at least one additional inspection entity wherein the first user terminal being configured for distributing data among the inspection entity and the at least one additional inspection entity.

According to an aspect of some embodiments of the present invention there is provided a method for establishing a disguised communication session between communicating user terminals. The method comprises providing at a first communicating user terminal a data for a communication session with a second communicating user terminal, and making the classification of the communication session by an inspection entity more difficult by distributing the data among a plurality of proxy network nodes and using each the proxy network node for forwarding a portion of the distributed data to the second communicating user terminal in a different flow.

Optionally, the data comprises a plurality of packets, for each the packet the making comprises changing a member of the group consisting of: a 5-tuple information, size, timing, and signature.

Optionally, the communication session is different from the flow a member of the group consisting of: transmission bandwidth, transmission rate, permissible error rate, and transmission delay.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a communication session between two communicating user terminals, according to some optional embodiments of the present invention;

FIG. 2 is a flowchart of a method for establishing a disguised internetwork communication session, such as a peer-to-peer session, between two or more communicating user terminals, according to some optional embodiments of the present invention;

FIG. 3 is a schematic illustration of an exemplary disguised communication session between a mobile phone and a personal computer, according to one embodiment of the present invention;

FIG. 4 is a schematic illustration of a number of networks, which are monitored by one or more inspection entities and connected to one another in internetwork channels; and

FIG. 5 is a flowchart of a method for classifying a disgusted communication session, according to one embodiment of the present invention.

### DESCRIPTION OF EMBODIMENTS OF THE INVENTION

The present invention, in some embodiments thereof, relates to a method and an apparatus for disguising a communication session and, more particularly, but not exclusively, to a method and an apparatus for disguising data of a communication session, such as a flow of packets that is inspected by an inspection entity.

According to an aspect of some embodiments of the present invention there is provided a method and an apparatus for establishing a disguised communication session, such as a peer-to-peer (P2P) session, for example a voice over internet protocol (VoIP) session, between two or more communicating user terminals, such as mobile phones, which are connected one or more networks. For clarity, it should be noted that the disguised communication session may include data of any type of communication and/or application.

The method allows a communicating user terminal that is connected to a network to establish a disguised communication session with another communicating user terminal utilizing a number of data flows, which are optionally established via proxy network nodes, such as neighboring user terminals. For clarity, a disguised communication session may be understood as a communication session having one or more characteristics changed in order to avoid the identification and/or the classification thereof by an inspection entity. Optionally, the communicating user terminal distributes packets of the communication session via local connections, as defined below, to a number of proxy nodes. Each proxy node forwards the received packets to the other communicating user terminal in an independent data flow that may be probed by an inspection entity. Optionally, some or all of the flows are directed to different network nodes which are connected to a remote communicating user terminal with which the communication session is established. As each flow is transmitted via different network nodes, the packets thereof have one or more so different routing tags, for example one or more different fields in the 5-tuple information that includes the protocol, two source fields, and two destination fields of each packet. As further described below, the 5-tuple information of packets of the communication session is changed in order to prevent from an inspection entity to associate between these packets and/or to classify them as part of an undesired communication session. Moreover, as the packets of the communication session are distributed in a number of flows, the inspection entity that receives the flows, possibly in different times, intercepts the packets in a number of different optionally unrelated flows and therefore may fail or have difficulty in classifying the packets as packets of a common communication session.

As described above, an inspection entity is designed to perform packet inspection and/or to enforce traffic management policies. As further described below, in some embodiments of the present invention the packets are packets of a communication session between first and second communicating user terminals. Optionally, the first communicating user terminal establishes local connections, such as peer-to-peer connections with a number of proxy network nodes, optionally proxy user terminals and distributes the data of the communication session among them. The proxy user terminals forward the data in flows to the second communicating user terminal, optionally via a respective group other proxy network nodes, optionally proxy user terminals, which are connected the second communicating user terminal.

Optionally, when possible, flows are routed via number of inspection entities. Such a distribution makes it harder or impossible for a particular inspection entity to classify the flows. Each one of the inspection entities that probes the flows receives only partial information about the communication session and therefore has either to estimate what is the content of the missing packets and/or to correlate information with other inspection entities.

Optionally, the transmitting user terminal may disguise a communication session, such as a P2P session, for example, a VoIP session, video conferencing session, online game session, and/or a file sharing session, by changing the traffic tags of the packets and distributing them in different flows. The changing of the traffic tags disguises each flow as a separate flow, such as a flow of a non peer-to-peer traffic, such as HTTP traffic, email traffic, FTP traffic, and other well-known applications.

The distribution into a number of flows disguises the traffic characteristics of the communication session, optionally as described below. For example, a user terminal may disguise the communication session by changing the 5-tuple data of each packet, for example by changing the source address, the destination address, and/or the protocol tag of each packet. In such a manner, a content inspection, which is based on the analysis of the traffic tags, may not classify the packets as packets of the disguised communication session. For example, flows of HTTP browsing can be made to look like an email synchronization using flow (IMAP) or an FTP download. In another example, flows of a VoIP conversation are disguised as HTTP browsing packets, flows of an FTP upload and download, Secure Shell (SSH) traffic over multiple connections, email fetching using POP, and/or sending using simple mail transport protocol (SMTP). In another example, flows of a video streaming are disguised as an FTP download over a single or multiple connections.

Optionally, when the protocol of a disguised flow requires a higher bandwidth than the protocol that is used for the disguising, for example when flows of a VoIP conversation are disguised as SSH traffic, multiple connections are used to achieve the required aggregated bandwidth. Optionally, when the protocol of a disguised flow requires less bandwidth than the protocol that is used for the disguising, dummy packets and/or data are sent to fill the missing rate.

Distributing the packets in different flows creates flows with traffic characteristics, such as data that is transferred per flow and burst characteristics, which are different from the traffic characteristics of a single flow that is used for forwarding packets of a communication session. A behavioral inspection that analyses such flows may not identify them as flows of the packets of the communication session as they are optionally transmitted in a slower pace than usual and optionally comprise fewer packets per flow. In such an embodiment, an inspection entity that is based on content and/or behavioral inspection may have difficulties to monitor the different flows and to classify the packets as packets of a communication session.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

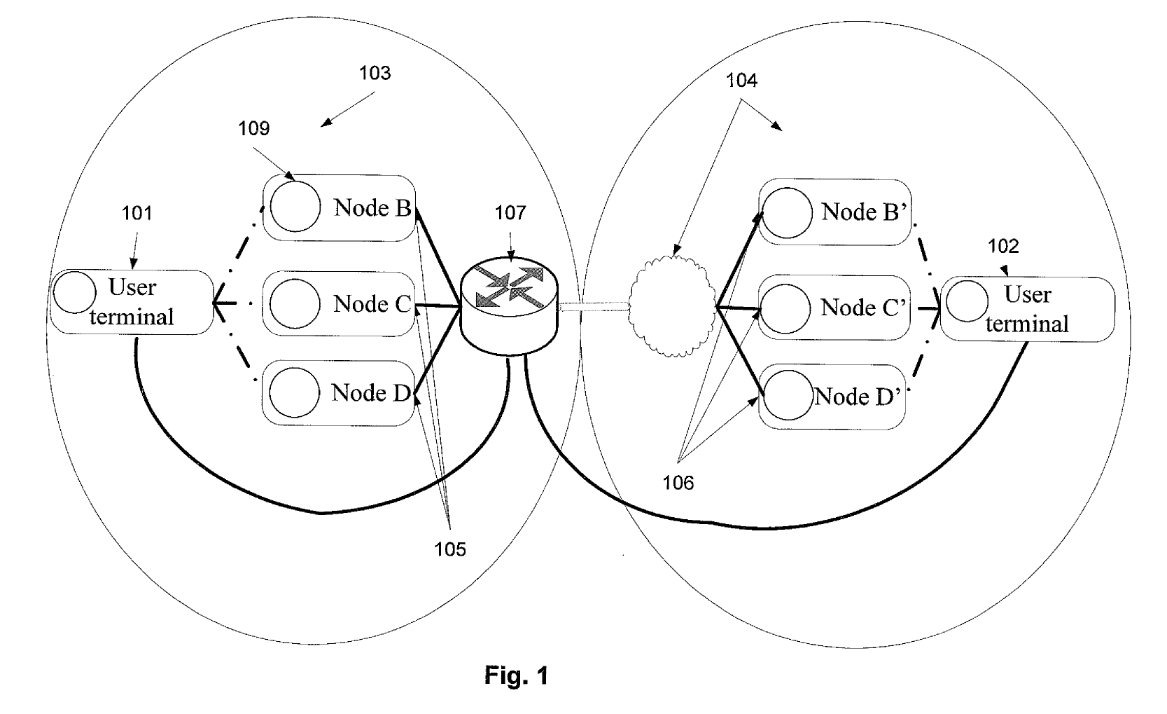

Reference is now made to FIG. 1, which is a schematic illustration of a communication session, which may be referred to as an internetwork communication between two communicating user terminals 101, 102, according to some optional embodiments of the present invention.

In FIG. 1, one of the user terminals 101 is connected to a network 103, or a segment of a network, which is monitored by an inspection entity 107 and may be referred to as a controlled network 103, optionally as described below, and another communicating user terminal 102 that is connected to another network or to another segment of the same network 104. It should be noted that the user terminals 101 may be controlled by a controller or any other unmanned module that is used for operating it in an automatic manner. As used herein, a user terminal also means a communication terminal that is designed to communicate with a user terminal and/or to interface between user terminals. The controlled network 103 and the other network 104 includes a number of network nodes, for example as respectively shown at 101, 105 and at 102, 106. As used herein, the term network node means a computing unit which can be used for receiving and forwarding data, such as a server and a user terminal for example a cellular phone, a personal digital assistant (PDA), a personal computer, and a laptop. Channels connecting between the networks 103, 104 pass via the inspection entity 107. The inspection entity 107 is positioned to probe internetwork communication between the network nodes 101, 105 of the controlled network 103 and network nodes 102, 106 of any other network 104. As used herein, the term controlled network means a communication network, or a segment of a communication network that includes a number of network nodes that the internetwork communication, which is the communication between them and network nodes, which are external to the communication network, is monitored by one or more inspection entities, as shown at 107. As used herein, the term a communication network means a group of network nodes which are connected via a certain ISP or a cellular provider, the Internet, a local Ethernet, a virtual private network (VPN), wide area network (WAN), a local area network (LAN), a wireless LAN (WLAN), or the combination thereof.

The network nodes 101, 105 of the controlled network 103 are connected by un-inspected communication channels (UCCs), which may be referred to as local connections. As used herein, the term UCC or local connection means a communication channel and/or a path that is not inspected by an inspection entity, for example as shown at 107. The local connection may be a wireless connection that is established over a cellular network, such as a general packet radio service (GPRS) connection, universal mobile telecommunications system (UMTS) connection, high-speed packet access (HSPA) connection, evolution-data optimized (EV-DO) connection, 3GPP long term evolution (LTE) connection, and evolved universal terrestrial radio access network (EUTRAN), and/or enhanced data rates for global evolution (EDGE) connection, which the specifications thereof are incorporated herein by reference. The local connection may also be a Bluetooth™ connection, an Infrared connection, a Wibree® connection, an unlicensed worldwide interoperability for microwave access (WiMAX™) connection, Wireless universal serial bus (USB), ZigBee, optionally as defined in IEEE 802.15.4 standards and/or a wireless fidelity (Wi-Fi) connection, optionally as defined in IEEE 802.11 standards, which the specifications thereof are incorporated herein by reference. Optionally, the UCC is a wired IP based connection that connects between nodes that the communication between them is probably not inspected, for example a connection between two nodes of the same ISP. It should be noted that an ISP usually deploys a CIE at points that its one or more networks connect to other networks.

The UCC enables an exchange of data between two network nodes that is not probed by the inspection entity 107. The networks 103, 104 are connected between them via inspected communication channels (ICCs), which may be referred to as internetwork channels. As used herein, the term ICC or an internetwork channel means a communication channel and/or a path that is inspected or potentially inspected by an inspection entity, such as the inspection entity that is shown at 107, for example as a global system for mobile communications (GSM) cellular connection, a licensed WiMAX™ connection, a code-division multiple access (CDMA) cellular connection, a cellular connection, such as GPRS and EDGE connection and/or a wired IP based connection, which the specification thereof are incorporated herein by reference. As used herein, the term inspection entity means a network node or an eavesdrop that is connected to a network node that monitors data flows in channels using content and/or behavioral inspection, such as a network node that classifies packets according to their 5-tuple and/or packet payload and/or according to an analysis of a flow that includes a sequence of packets in order to identify the type of the flow, for example identifying whether the flow is part of a VoIP or file sharing session, a web browsing session, or an email transmission session.

The inspection entity 107, as known inspection entities, performs a content inspection to packets that pass through the internetwork channels. When a content inspection is performed, the inspection entity 107 probes the packets and classifies the data session to which they belong as one of a number of possible types. Such a probing may be based on a protocol state machine that probes the packets and identifies them according to which protocol they have been formed, for example whether the packets are formed according to hypertext transfer protocol (HTTP) or file transfer protocol (FTP), which are incorporated herein by reference. The inspection entity 107 may also search for known signatures that disclose the underlying protocol type. The inspection entity 107 may be designed to extract packets that have one or more characteristics of a certain traffic type, thereby to prevent the establishment a certain communication session.

The inspection entity 107 may perform behavioral inspection to packets that pass through the internetwork channels. When a behavioral inspection is performed, the inspection entity 107 utilizes traffic pattern matching algorithms, which monitor parameters like packet size, packet timing, overall data transferred, session bandwidth, transmission bandwidth, transmission rate, permissible error rate, transmission delay, changes in session bandwidth over-time, and inter-packet delay. The behavioral inspection entity 107 may not look at the content itself but rather on the modus operandi of the session in order to match the flows to known traffic pattern.

In some embodiments of the present invention, a network node 101, such as a communicating user terminal 101, for example a computer network or a cellular phone, may be used for establishing a disguised communication session, such as a VoIP session, via one or more network nodes 105, such as other user terminals, in the controlled network 103. For clarity, a sequence of packets that is transmitted in a connection between the communicating user terminals 101, 102 may be referred to as a flow or a data flow.

In such embodiments, the data, optionally the packets, of the disguised communication session are changed and/or routed, optionally as described below, in a manner that the inspection entity 107 that inspects the controlled network 103 may not identify or may have difficulties to identify probed packets as packets of the disguised communication session. The network nodes 105, 106, which are used as proxy nodes in the communication between the user terminals 101, 102, may be referred to as proxy nodes 105, 106.

It should be noted that the channels, which are used for forwarding the flows, may be used for establishing a disguised bidirectional communication session between the two or more communicating user terminals 101, 102.

It should be noted that in general, the aforementioned disguised method may be used to disguise VoIP related services, such as Voice Mail (VM). It should be noted that the flows which are used for carrying the disguised information may be used as tunnels of data and therefore do not change the functionality of the application which are hosted in the user terminals and use the data that is passed via the tunnels. A user terminal may host a VoIP application that uses a session initiation protocol (SIP) in a communication with one IP address and real-time transport control protocol (RTCP) or real-time transport protocol (RTP) in a communication with another IP address. Optionally, a different bundle of flows may be used for disguising each one of these communications. The tunnel like behavior is achieved with a software module that is installed in the user terminal 101. The software module encapsulates any connection and/or flow of one or more of the applications of the user terminal 101 in a number of different flows. The connections and/or flows may include communication information, such as VoIP data or data that is related to related services such as VM.

In some embodiments, actions of the communicating user terminal 101 and/or characteristics thereof are performed and/or characterize the other communicating user terminal 102 and vice versa.

According to some embodiment of the present invention, the aforementioned communication session is designed for increasing the anonymity of the users of the user terminals 101, 102 that participate in the disguised communication session. In such an embodiment the addresses of the user terminals 101, 102 are concealed by forwarding the data of a communication session via a number of proxy nodes.

Optionally, the aforementioned communication session is designed for to thwart eavesdropping attempts. Optionally, all or some of the proxy nodes 105, 106 are managed by an anonymity or security service provider. As used herein anonymity means concealing the address of the communicating user terminals, for example 101 and 102. Such a security service provider may allow user terminals, such as servers of banks, dating sites, gambling sites, and the like, to use the proxy nodes 105, 106 for establishing communication sessions, optionally as described above. Optionally, each user terminal installs a shim module that allows the association thereof with the proxy nodes 105, 106, which may be referred herein as an anonymity network. For clarity, eavesdropping and analyzing a communication between any two or more proxy nodes 105, 106 cannot induce any information about the source address and/or destination address of a communication session that is established via the anonymity network and therefore the anonymity network increases the anonymity of the communicating user terminals that participate in the communication session.

Optionally, the communication session data is routed in an onion routing technique, see Reed, M., Syverson, P., and Goldschlag, D. Anonymous connections and Onion Routing. IEEE J. Selected Areas in Commun. 16, 4 (May 1998), 482-494, which is incorporated herein by reference.

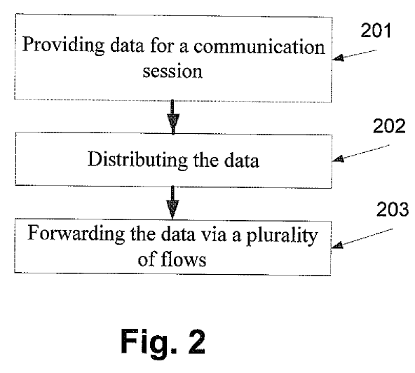

Reference is now also made to FIG. 2, which is a flowchart of a method for establishing a disguised internetwork communication session, such as a peer-to-peer (P2P) session, between two or more communicating user terminals, according to one embodiment of the present invention. The communicating user terminals are optionally connected to different networks, for example as shown at 101, 102.

First, as shown at 201, one of the user terminals 101 creates and/or provided with packets for a communication session with a communicating user terminal 102. Optionally, the packets are defined according to a commonly known communication protocol, such as a VoIP, for example real time control protocol (RTCP) XR (RFC3611), session initiation protocol (SIP) RTCP summary reports, H.460.9 annex B (for H.323), H.248.30, and media gateway control protocol (MGCP) extensions, which are incorporated herein by reference. Then, as shown at 202, the session packets are distributed, optionally via local connections, among a number of network nodes 105 of the controlled network 103, which may be referred to as proxy nodes 105.

Now, as shown at 203, each one of the proxy nodes 105 forwards the received packets in a different flow to the communicating user terminal 102. Optionally, each one of the flows is forwarded to a proxy network node, as shown at 106, which is connected, optionally in a local connection, to the communicating user terminal 102.

Optionally, each flow is forwarded in a separate channel. Optionally, the channels, which are used for forwarding the packets, are used for establishing a bidirectional communication session between the two or more user terminals 101, 102. Such a bidirectional communication session may allow the establishment of a VoIP session, a video conference session, and a participation in an interactive game.

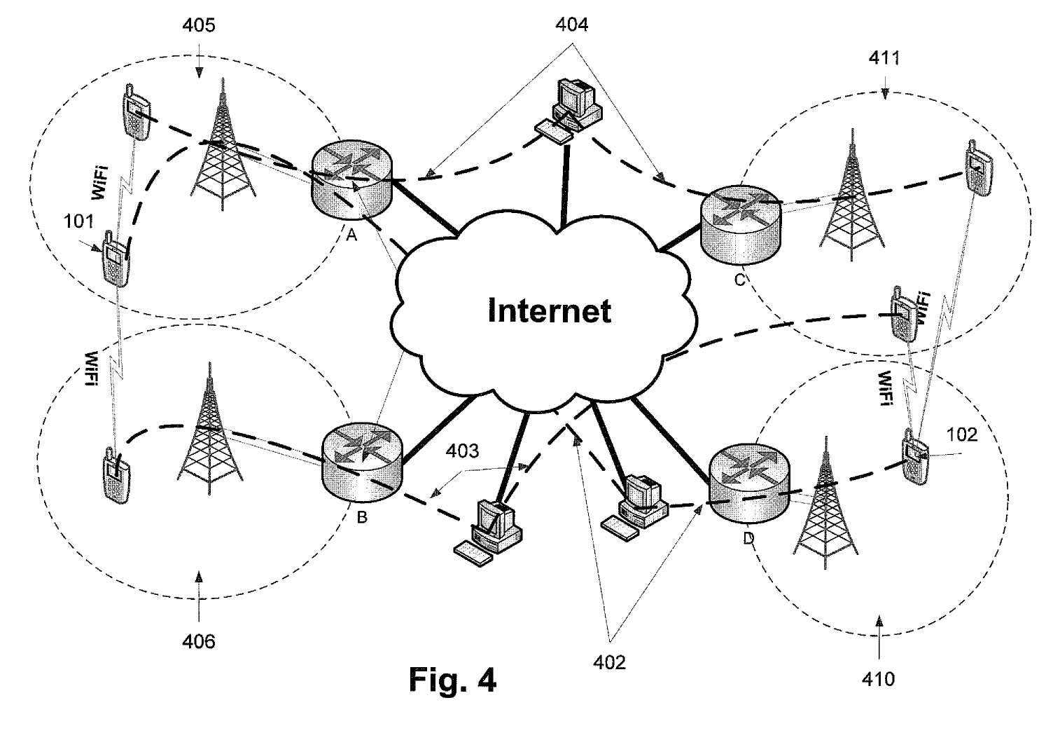

Optionally, each one of the proxy nodes 105 hosts a module, for example as shown at 109, that is used for managing the received packets and for generating the flows, as described above. Optionally, the application 109 which is installed in the user terminals 101, 102 is designed to identify the one or more proxy nodes 105, 106 and to establish a UCC with each one of them. The application 109 may also be used for determining the paths by identifying intermediate nodes, for example as shown in FIG. 4 or 105, 106 in FIG. 1. Optionally, the paths are determined using a central network node, such as a database, which is referred to herein as a registration server. Optionally, when the terminal user is used as a proxy, for example as shown at 105, 106, the application 109 is used for managing the traffic which is received via the UCC and forwards the data it receives to the one or more ICCs while maintaining the traffic characteristics. Optionally, the application 109 reports the current mode of the user terminal 101, 102 to a central network node. Examples for possible modes are available as a node proxy, idle, unavailable as a proxy node.

Optionally, the application 109 changes, optionally as described above, the source IP address and/or the source port of each packet it receives for forwarding, as shown at 203. In such a manner, the inspection entity 107 may have difficulties or fail to associate between packets from different flows as each one of them has a different source IP address and/or source port. Optionally, each proxy port designates another network node outside the controlled network 103.

For example, if the nodes are mobile phones, the identification process is as follows: first, each mobile phone periodically searches for other mobile phones, for example using its WLAN and/or Bluetooth™ interfaces. This enables the mobile phone to detect potential proxy nodes in an event that it may establish a disguised communication session, such as a VoIP session. Periodically, each mobile phone connects to a registration server that hosts the status of a number of subscribers, optionally via an internet connection, refreshes its status, and/or optionally the status of other mobile phones or communication terminals in the proximity thereof. The status may include a telephone number, an IP address, and/or a list of mobile devices it can use as proxy nodes. Once a mobile phone establishes a communication session, it connects to the registration server and requests for a path to another communication terminal, such as a mobile phone or a PSTN phone, optionally by submitting the phone number and/or another identifier of the requested communication terminal. Optionally, the mobile phone also sends an update that includes the current local proxy nodes it can use. The registration server searches for the status of the requested communication terminal. Optionally, for example if the status of the requested communication terminal is not updated, the registration server establishes a connection with the requested communication terminal in order to verify the path thereto. The registration server optionally uses the data in its memory for contact the requested communication terminal. After the connection is established, for example by using the memory to find a path from the registration server to the requested communication terminal via a number of proxy nodes, the registration server may ask the user of the requested communication terminal to authorize the request for establishing a connection therewith. Once the registration server identifies the current status of the requested communication terminal, it uses the list of local proxy nodes of the mobile phone and the requested communication terminal to establish a path that will connect between them, for example as shown at 402-404 of FIG. 4. Optionally, the registration server performs an analysis of the geographical location of the related nodes, optionally according to their IP, in order to identify the shortest path. The identified path is sent to the mobile phone and to the requested communication terminal. Optionally, the path includes explicit path information, such as the IP addresses of the proxy nodes that should be used. Optionally, the registration server notifies the proxy nodes that such a communication session is about to take place. Now, the mobile phone and the requested communication terminal establish a connection via the identified path. Once a proxy node receives a connection, it creates a bridge between it and another proxy node, optionally as described above.

When the communication session is established via an ICC that is a wired IP connection, local proxy nodes may be identified in a different manner. Local proxy nodes, or nodes connected over UCCs, can be defined as any node that is connected via a common ISP or a common Ethernet. In use, each wired IP node performs a path discovery to the registration server, optionally by running a traceroute algorithm. The registration server compares the receptions from all the wired IP nodes and classifies them according to common segments, such as a common prefix. In such a method, the registration server may supply each accessing node with a list of nodes that can act as local proxy nodes.

Optionally, when a new node is registered to the registration server, it submits its IP address. The registration server checks if the node is behind a network address translation (NAT). If so, all the nodes behind the same NAT address are assumed as being able to establish a UCC. If there is no NAT, for example if the IP of the node is provided to the server directly by the node, then the server looks for other nodes from the same subnet or network. In such an embodiment, the registration server supplies the node with a list of local proxy nodes. Optionally, the IP subnet broadcast address of each node, which is used for finding local proxy nodes with which a UCC, may be established. For clarity, even wired connected devices can be connected to a wire IP device via a Wi-Fi connection, for example via a home Wi-Fi router and therefore local proxy nodes may be searched directly over WiFi even though the wired IP node is not connected thereto via wired IP

For example, nodes A, B, and C at the controlled network 103 respectively designates nodes A′, B′, and, C′. Optionally, each application 109 changes the so destination IP address and/or destination port of each packet it receives for forwarding, as shown at 203. In such a manner, the inspection entity 107 may have difficulties or fail to associate between packets from different channels based on their destination IP address, source IP address, and/or destination port. In such an embodiment, each one of the designated nodes, for example nodes A′, B′, and. C′, is configured to forward the received packets to their original destination IP address and/or destination port. Optionally, each one of these proxy nodes 106 hosts a module that is designed to forward the received packets, as described above.

It should be noted that the communicating user terminals 101, 102 may change the proxy nodes 105, 106 they use. In such a manner, the inspection entity may fail or find difficulties to map the proxy nodes 105, 106 that the communicating user terminals 101, 102 may use.

Optionally, a preliminary stage in which the user terminals 101, 102 notify one another about the proxy nodes 105, 106 is held before the disguised communication session begins. In such a manner, each communicating user terminal 101, 102 can respectively notify the proximate proxy nodes 105, 106 with the information that is needed to allow the disguised communication session. For example, each proxy node 105, 106 receives the destination IP address and/or the destination port of a respective network node 106, 105 that is connected to a respective remote communicating user terminal 102, 101 and the destination IP address and/or destination port of the respective proximate communicating user terminal 101, 102 to which it forwards received packets.

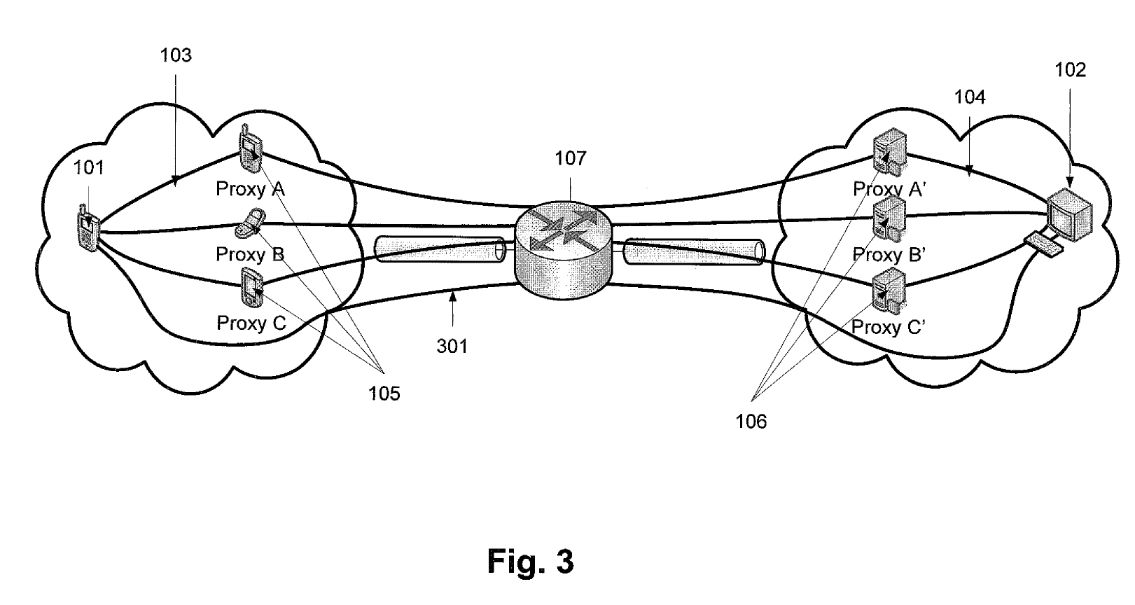

Reference is now made to FIG. 3, which is a schematic illustration of an exemplary disguised communication session between two communicating user terminals, optionally a mobile phone and a personal computer, according to one embodiment of the present invention. The inspection entity 107 is as depicted in FIG. 1, however in FIG. 3 the controlled network 103 is a cellular network 103, network nodes 101, 105 are cellular phones, and the other network 104 is the Internet with servers, and the other hosting computing units 102, 106 are defined as network nodes.

When a cellular device, such as a communicating cellular phone, as shown at 101, establishes a disguised communication session, such as a VoIP session, with another device, such as a personal computer, for example as shown at 102, it sets up local connections with a group of mobile devices 105 that function as proxy nodes 105, for example as described above. Each one of these mobile devices 105 establishes an internetwork channel with a server on the internet that is connected to the communicating personal computer 102. Each one of these internetwork channels allows the forwarding of different data flows between the proxy mobile devices 105 and the proxy servers 106, which are probed by the inspection entity 107. As described above, the local connections that connect the mobile devices and/or the local connections that connect the servers are not probed by the inspection entity 107. For instance, the traffic between the communicating cellular phone 101 and the proxy mobile devices 105 does not pass through the inspection entity and therefore may be probed.

As described above, the packets of the communication session are distributed in the aforementioned flows. Each packet is originated from the mobile device 101 and passes via one or more proxy nodes and via the inspection entity 107 toward the communicating personal computer 102. As depicted, the inspection entity 107 receives the data from proxy nodes. The inspection entity 107 probes the flows. Each flow carries only a part of the communication session. As each flow passes through a different proxy node before it is probed by the inspection entity 107, it has a different 5-tuple, as further described above. It should be noted that one of the flows may be forwarded via a channel that is established between the mobile phone 101 and the personal computer 102 without proxy nodes, as shown at 301. It should be noted that local connections between the mobile phone 101 and the proxy nodes 105 may be Bluetooth™ connections, Wi-Fi™ connection, wired IP based connections, or cellular connections, as further described above.

Optionally, the mobile phone 101 and/or one or more of the proxy nodes 105 obscure the protocol of the data that is transmitted in the packets of flows. Such an obscuration may include changing and/or reducing characteristics and tags, which are associated with a certain protocol and may be used by the inspection entity 107 for identifying the data that is transmitted over the flow

In one embodiment of the present invention, the application 109 uses a packet scheduler for sending the data of the communication session over the ICCs. The packet scheduler determines when packets should be sent and/or their size. Optionally, the size and/or timing are determined according to a protocol of a session that is emulated by the disguised communication session, optionally as described below. Each one of the ICCs is optionally established only after two nodes that participate in the aforementioned communication session agree on a protocol, which is optionally defined by the application 109 of one of the communicating user terminals 101, 102.

The packet scheduler uses one or more protocol definitions (PDs) for determining the size and/or transmission timing of the packets. Each PD includes data that enables the packet scheduler to emulate the size and/or the transmission timing of packet in a manner that emulates the behavioral pattern of a known protocol. If the data of the PD enables the packet scheduler to emulate the behavioral characteristics such as packet size, packet timing, overall data transferred, session bandwidth, transmission bandwidth, transmission rate, permissible error rate, transmission delay, changes in session bandwidth over-time, inter-packet delay, or any combination thereof.

Optionally, the packet scheduler is associated with a data buffer that may be used for determining the payload of transmitted packets. Optionally, if the data buffer is not full at the timing that is defined in the PD the packet scheduler pads it with dummy data and transmits its content, optionally as described above. Optionally, in order to avoid redundant padding, the packet scheduler delays the transmission as long as possible. Optionally, in order to maintain the PD the delay is compensated by sending more data in the following time quantum. Optionally, a version of a traffic shaping method is used for maintaining the PD. Such traffic shaping methods are known to one of ordinary skill in the art and, thus, will not be further elaborated herein.

If the PD describes a protocol that sends packets both ways, the packet schedulers of the nodes that establish ICC connection exchange state information, optionally by sending predefined information via the packets they transmit. Optionally, the exchange state information contains information about the state of the PD that they are currently emulating. If a skew occurs during the emulation, the packet scheduler slows down or speeds up the replay in order to resynchronize the emulated protocol.

Reference is now made to FIG. 4, which is a schematic illustration of a number of controlled networks 405-406 and 410-411, which are connected to one another in internetwork channels. As described above, some of the packets of the disguised communication session may be routed in a manner that not all the packets transferred to their destination via the same inspection entity.

Optionally, if more than one inspection entity is used for inspecting all the internetwork channels of a certain controlled network, flows are routed via different inspection entities. The monitoring of a network using a number of inspection entities is common in large networks in which the volume of the traffic that has to be probed is considerably high, for example in large cellular networks which are controlled by a single provider. For example, FIG. 4 optionally depicts two segments 405, 406 of a large cellular network. The segments are connected by channels and the communication between network nodes in each segment is not probed by any of the related inspection entities 407. For example, in the networks, which are depicted in FIG. 4, the communicating user terminal 101 may distribute packets of a communication session with another communicating user terminal 102 in flows that pass via inspection entities A, B, C, and D as respectively shown at 402, 403, and 404.

Optionally, the communicating user terminal 101 is able to be connected simultaneously to two or more network nodes of two or more different controlled networks without any proxy node. In such an embodiment, the communicating user terminal 101 may route traffic through multiple inspection entities and achieve the same outcome. For example, if the communicating user terminal 101 is a device that supports a multiple subscriber identification module (SIM) card, it may forward packets to the destination via a number of cellular networks without using any proxy node. In another example, the communicating user terminal 101 may distribute packets of a communication session via a Wi-Fi connection and a cellular connection simultaneously.

In one embodiment of the present invention, the communicating user terminal 101 is designed to disguise packets of a certain communication session by applying changes that conceal the protocol that has been used to encode them from an inspection entity.

For example, an HTTP 1.1 session passes data in one direction in packets that have a maximum size and optionally in a maximum speed. Then the connection terminates, for example when the requested webpage has been downloaded, or restored when another page is download, for example when the user clicks on a hyperlink. An FTP session is built from a control connection that passes very small amounts of information and multiple data connections each starts, transfers large chunks of data at max speed and max packet size, and terminates. VoIP connection without quite-time bandwidth reduction has a relatively low bandwidth, 64 Kbps, and constant bit rate.

The behavioral pattern of a certain communication session may be disguised by emulating the behavioral pattern of another communication. Such an emulation may include changing the packet sizes, the inter packet timing, the bandwidth, and the delay between transactions of the communication session according to the emulated communication. Optionally, the emulation is base on recording the behavioral pattern a communication session and instructing a packet scheduler to issue the packets having the same characteristics during the aforementioned disguising process in order to emulate the behavior of the emulated session.

Optionally, the communicating user terminal 101, 102 determine the data rate and/or the inter-packet timing of each one of the ICCs, assuring that it does not exceed the data rate and/or the inter-packet timing of the behavioral pattern of emulated session.

Optionally, the user terminal 101, 102 distributes packets of the disguised communication session to ICCs when the behavioral pattern of the emulated session requires packets to be sent on that connection. As described above, the packets are sent either via the proxy nodes 105, 106 or directly. Optionally, if the disguised communication session does not send packets when the behavioral pattern of the emulated session requires packets to be sent on that connection the user terminal 101, 102 creates and sends dummy packets. In a similar manner, proxy nodes 105, 106 can also create the dummy packets. In such a manner, the dummy packets are not sent over UCCs.

Optionally, upon establishing a UCC, and in any point in time later on, the user terminal 101, 102 receives from each proxy node information about the amount of data it can transmit and/or the maximum transmission rate receive. Optionally, the user terminal 101, 102 stores this information each of some or all of the proxy nodes 109 and tracks how much data it sends in each time quantum. Based on this information the user terminal 101, 102 can select ICCs to establish the disguised communication session, optionally in a resource-aware, disguised-session-bandwidth-aware, round robin, and/or random manner. Optionally, the user terminal 101, 102 stores counts how much data has been sent to each proxy node in predefined time quantum and use the counts to calculate which ICC is suitable for sending data such that data delivery will be on time and that optionally the padding of dummy data is minimal.

As described above, an inspection entity may be used to enforce a data transfer policy of a managing entity, such as a service provider. An inspection entity that implements such a policy determines whether a flow is blocked or not and/or the QoS that it receives. Flows may be classified either as an uncontroversial flow (UF) that receives relativity high QoS or as a censored flow (CF) that may be blocked and/or receive a low QoS. Usually, non peer-to-peer traffic, such as HTTP traffic, email traffic, FTP traffic, and other well-known applications are defined as UF protocols.

In such an embodiment, a flow that comprises packets of the communication session is transformed to a flow that comprises packets formed according to a UF protocol, such as HTTP traffic packets.

As described above, an inspection entity may be configured to perform content and behavioral inspections. Transforming a flow of a communication session to a flow that comprises packets formed according to a UF protocol changes content characteristics of the packets, for example the formatting of the packet. However, as such, the traffic pattern of the packages is not changed; an inspection entity that performs a behavioral inspection may still identify the packets as packets of the communication session. For example, while VoIP communication is based on a constant packet rate with unchanging bandwidth and constant inter packet timing, HTTP 1.0 data is sent in bursts with large packets and multiple simultaneous connections.

In order to change the traffic pattern of the packages, one or more packet characteristics, such as size, timing, and signature, and flow characteristics, such as bandwidth, transmission bandwidth, transmission rate, permissible error rate, transmission delay, the total data that is transferred per flow, and burst parameters, may be changed. Optionally, in order to change these characteristics, the session traffic is transformed to a number of disguised UF flows that include, when combined, all the data of the communication session. The UF flows may be transmitted sequentially or concurrently. If the communication session is under strict timing constrains or throughput requirements its packets should be broken into parallel disguised UF flows, for example as described above.

Optionally, the flows are padded with dummy data in order to obtain traffic characteristics of a disguised UF flow.

Optionally, a bidirectional communication session is disguised as two unidirectional communication sessions, such as FTP download and upload sessions. In such an embodiment, communication packets from a first terminal are sent to a second terminal as packets of a unidirectional communication session and communication packets from the second terminal are sent as packets of another unidirectional communication session.

Optionally, the data of the disguised communication session is transformed into short sequences that emulate flows of a limited amount of data. In such a manner, a behavioral inspection algorithm may not have sufficient data to identify the flow as a CF Such an embodiment may be used to disguise data from an inspection entity that classifies flows according to their size.

A potential advantage of such an embodiment is robustness. As the communication session is based on a number of flows, a disconnection of one or more of the flows do not substantially damage the connectivity of the communication sessions as the other flows are maintained.

It should be noted that correlating the flows in order to identify whether they are part of a disguised communication session has relatively high computational complexity. An inspection entity 107 that monitors a relatively small network handles simultaneously approximately 50,000 flows on average. If the inspection entity 107 searches for a correlation among K flows in a sum of N flows, the computational complexity is:

$$O ( ( \begin{matrix}N \\ K\end{matrix} ) )$$

For example, if K=4 and N=50000, the computational complexity is about:

$$O ( ( \begin{matrix}50000 \\ 4\end{matrix} ) ) \approx 2.6 \cdot {10}^{17}$$

For example, a single session of a bank transaction may be split to multiple flows which are disguised as flows of an email download, HTTP browsing and/or VoIP communication.

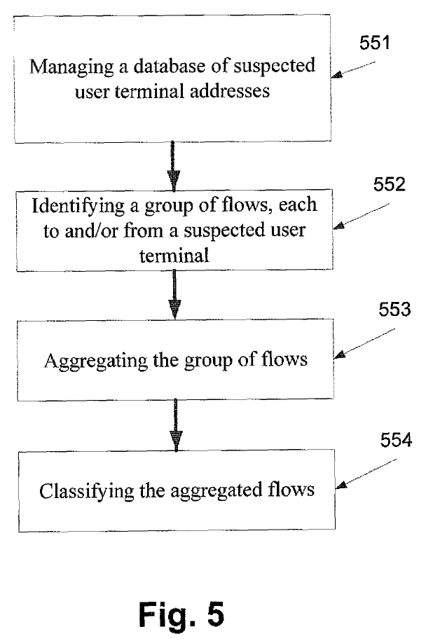

Reference is now also made to FIG. 5, which is a flowchart of a method for classifying a disgusted communication session, according to one embodiment of the present invention. First, as shown at 551, a database of user terminals, which are used for establishing such disgusted communication sessions, is managed. Such a database optionally includes a list of known unique addresses, such as IP addresses, of the user terminals. Then, as shown at 552, the CIE 107 is configured to eavesdrop to the flows and to identify a group of flows, which are sent via these unique addresses and originated from or sent to one of the user terminals. Optionally, in order to reduce the size of the group, the CIE 107 checks the starting timing in which these user terminals have begun to communicate and selects the members that have a common starting timing.

Then, as shown at 553, the CIE 107 aggregates the behavioral patterns of these flows to an aggregated behavioral pattern. The CIE 107 matches between the aggregated behavioral pattern and known behavioral patterns and classify, as shown at 554, the aggregated behavioral pattern according to the match. Optionally, if the aggregated behavioral pattern is classified as a restricted communication session, the CIE blocks the aggregated flows.

It is expected that during the life of a patent maturing from this application many relevant systems and methods will be developed and the scope of the terms channels, connections, links, and networks, are intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A method for establishing a disguised communication session between communicating user terminals, comprising:
at a first communicating user terminal, providing data for a communication session with a second communicating user terminal;
distributing said data among a plurality of proxy network nodes; and
using said plurality of proxy network nodes for forwarding a plurality of flows to said second communicating user terminal, each said flow comprising a portion of said data;
wherein said distributing and forwarding is performed so as to disguise at least one characteristic of said communication session from at least one inspection entity probing said plurality of flows.

2. The method of claim 1, wherein said at least one characteristic is a behavioral pattern.

3. The method of claim 1, wherein said disguising prevents from said at least one inspection entity from receiving said data in a single flow.

4. The method of claim 1, wherein said plurality of proxy network nodes comprises at least one proxy user terminal.

5. The method of claim 1, wherein said plurality of proxy network nodes are configured for forwarding said plurality of flows in parallel.

6. The method of claim 1, wherein said data comprises a plurality of packets each has at least one routing tag, said distributing comprising changing said at least one routing tag.

7. The method of claim 6, wherein said at least one routing tag is a 5-tuple information.

8. The method of claim 1, wherein said communication session comprises a member of the group consisting of: a voice over internet protocol (VoIP) session, video conferencing session, online game session, and a file sharing session.

9. The method of claim 1, wherein each said proxy network node receives said portion via an intranetwork connection, said intranetwork connection not being monitored by said at least one inspection entity.

10. The method of claim 9, wherein said intranetwork connection is a peer-to-peer connection.

11. The method of claim 1, wherein said proxy network node is configured for forwarding a respective said flow via an additional proxy network node connected to said second communicating user terminal.

12. The method of claim 11, wherein said additional proxy network node is connected in a peer-to-peer connection to said second communicating user terminal.

13. The method of claim 1, further comprising padding each said flow with dummy data before said forwarding.

14. The method of claim 1, wherein said communication session is a bidirectional session, said disguising comprising disguising said flow as a flow of a unidirectional communication session.

15. The method of claim 1, wherein each said flow is shorter than a flow of a non peer-to-peer (P2P) data traffic.

16. The method of claim 1, wherein said using comprises routing said flows to be probed by a plurality of inspection entities.

17. The method of claim 1, wherein said disguising is performed to increase the anonymously of said first communicating user terminal.

18. A method for classifying a disgusted communication session, comprising:
managing a list comprising plurality of suspected user terminal addresses;
reviewing a plurality of eavesdropped flows to select a group of eavesdropped flows each being related to one of said plurality of suspected user terminal addresses;
aggregating said group of flows to induce an eavesdropped behavioral pattern;
reviewing a plurality behavioral pattern each of a known communication session to select a match with said eavesdropped behavioral pattern; and
classifying said group of flows according to said match.

19. The method of claim 18, wherein each said eavesdropped flow comprises at least one of said plurality of suspected user terminal addresses as a destination address or as a source address.

20. A method for concealing the address of communicating user terminals, comprising:
at a first communicating user terminal having a first address, providing data for a communication session with a second communicating user terminal having a second address;
distributing said data among a plurality of proxy network nodes; and
using said plurality of proxy network nodes for forwarding a plurality of flows to said second communicating user terminal, each said flow comprising a portion of said data;
wherein said distributing and forwarding is performed so as to conceal said first and second addresses from at least one entity eavesdropping said plurality of flows.

21. An apparatus for establishing a communication session with a communicating user terminal, comprising:
a communicating module configured for establishing a plurality of connections with a plurality of proxy network nodes; and
a session module configured for distributing data of the communication session via said plurality of connections, thereby using said plurality of proxy network nodes for disguising the communication session as a plurality of flows forwarded to the communicating user terminal, each said flow comprising a portion of said data;
wherein at least one characteristic of said communication session is concealed from at least one inspection entity probing at least one of said plurality of flows.

22. The apparatus of claim 21, wherein said apparatus is a member of the group consisting of: a mobile phone, a personal digital assistant (PDA), a laptop, and a personal computer.

23. The apparatus of claim 21, wherein said communicating module is configured for establishing a plurality of peer-to-peer connections with said plurality of proxy network nodes.

24. The apparatus of claim 21, wherein said session module is configured for padding said data with dummy data before said distributing.

25. The apparatus of claim 21, wherein said communication session is a bidirectional session, further comprising a receiving module for receiving data flows from the communicating user terminal.

26. The apparatus of claim 21, wherein said data flows are received via said plurality of connections.

27. The apparatus of claim 21, wherein said communication session is configured for distributing said data to be routed via a plurality of different inspection entities.

28. A system for allowing at least two user terminals to establish a disguised communication session, comprising:
at least one inspection entity configured for performing an inspection to at least one channel between a plurality of network node; and
a first and a second user terminal configured for establishing a communication session via said channels;
wherein said first user terminal is configured for distributing data of said communication session via said channels in at least two flows so as to disguise at least one characteristic of said communication session from an inspection entity probing said plurality of flows.

29. The system of claim 28, further comprises at least one additional inspection entity wherein said first user terminal being configured for distributing data among said inspection entity and said at least one additional inspection entity.

30. A method for establishing a disguised communication session between communicating user terminals, comprising:
providing at a first communicating user terminal a data for a communication session with a second communicating user terminal; and
making the classification of said communication session by an inspection entity more difficult by distributing said data among a plurality of proxy network nodes and using each said proxy network node for forwarding a portion of said distributed data to the second communicating user terminal in a different flow.

31. The method of claim 30, wherein said data comprises a plurality of packets, for each said packet said making comprises changing a member of the group consisting of: a 5-tuple information, size, timing, and signature.

32. The method of claim 30, wherein said communication session is different from said flow a member of the group consisting of: transmission bandwidth, transmission rate, permissible error rate, and transmission delay.
